(19) United States
(12) Patent Application Publication
(10) Pub. No.: US 2009/0202868 A1
(43) Pub. Date: Aug. 13, 2009

(54) FUEL CELL UNIT OF DMFC TYPE AND ITS OPERATION

(75) Inventors: Olof Dahlberg, Vintrosa (SE); Alf Larsson, Karlskoga (SE)

Correspondence Address: PILLSBURY WINTHROP SHAW PITTMAN, LLP, P.O. BOX 10500, MCLEAN, VA, 22102, US

(73) Assignee: Morphic Technologies Aktiebolag (Publ.), Karlskoga (SE)

(21) Appl. No.: 12/304,903

(22) PCT Filed: Jun. 14, 2007
(86) PCT No.: PCT/SE2007/050419

§ 371 Date: Mar. 10, 2009

(30) Foreign Application Priority Data
Jun. 16, 2006 (SE) 0601350-2

(51) Int. Cl. H01M 12/00; H01M 8/06

(52) U.S. Cl. 429/9; 429/17

(57) ABSTRACT

A DMFC fuel cell, in which liquid methanol is oxidised to carbon dioxide and water, the methanol is exposed to an anodic reaction using a catalyst, the reaction products are led to a second step, where an anodic reaction is performed using a catalyst, and the reaction products from the second step are led to a third step, where an anodic reaction is performed using an optimal catalyst. The three reaction steps are connected flow-wise in series in a fuel cell unit, and the supply of oxidant is controlled such that the reactions on the anodic and the cathodic sides are in stoichiometric balance with each other in every step. Hydrogen peroxide is preferably used as an oxidant. Liquid ethanol can be used as fuel. The ethanol is oxidised to carbon dioxide, and methanol and in the second unit the methanol is oxidised to carbon dioxide and water.

### TECHNICAL FIELD

The present invention relates to a method of operation of a fuel cell of DMFC type, in which an aliphatic, short chain, water soluble, liquid alcohol of the general formula RCH₂OH, aldehyde of the general formula RCHO or acid of the general formula RCOOH, where R denotes H, CH₃, C₂H₅ or C₃H₇, is oxidized to carbon dioxide and water.

The invention also relates to a fuel cell unit of DMFC type, which unit comprises an anodic side having an anode and a catalyst for the anodic reaction, a cathodic side having a cathode and a catalyst for the cathodic reaction, as well as an intermediate membrane that separates the anodic and cathodic sides from each other.

### PRIOR ART

Fuel cells driven by direct methanol are previously known, see for example Alexandre Hacquard, Improving and Understanding Direct Methanol Fuel Cell (DMFC) Performance, (Thesis submitted to the faculty of Worcester Polytechnic Institute) published on http://www.wpi.edu/Pubs/ETD/Available/etd-051205-151955/unrestricted/A.Hacquard.pdf. Among attainable advantages can be mentioned that the fuel is liquid, thus enabling fast fuelling, that both the fuel cell, that can be given a compact design, and the methanol, can be produced at low costs, and that the fuel cell can be designed for a number of different stationary or mobile/portable applications. Fuel cells of DMFC type are furthermore environmentally friendly, only water and carbon dioxide are discharged; no sulphur or nitrogen oxides are formed.

The most significant drawbacks of known fuel cells of DMFC type are that the power density has been too low, due to slow electrochemical oxidation of methanol at the anode, and that methanol has been able to migrate through the PEM membrane (Polymer Electrolyte Membrane) to the cathode where the methanol has oxidised. This results not only in fuel loss, but also in that the platinum catalyst used at the cathode is poisoned by formed carbon monoxide, which leads to decreased efficiency. The complexity of the reactions has made it difficult to achieve a satisfying yield. The membrane's capacity of transporting protons (hydroxonium ions) from the anode to the cathode is furthermore limited and is easily exceeded, as each methanol molecule gives rise to six protons that are to pass through, which differs from the circumstances in a hydrogen fuel cell in which hydrogen forms two protons per hydrogen molecule.

### BRIEF ACCOUNT OF THE INVENTION

The main object of the present invention is to achieve higher power density in fuel cells of DMFC type, i.e. higher output power from a fuel cell of a given size and that a fuel cell of given power should be less space consuming.

In the method mentioned in the introduction, this object is achieved according to the invention by: if starting from said acid, exposing it to a reaction step of a desired anodic reaction for the forming of carbon dioxide, an alcohol with one carbon atom less than said acid, or, if R denotes H, water, and liberating protons and electrons with use of a catalyst optimised for this reaction, if starting from said aldehyde, in a preceding reaction step exposing it to a desired anodic reaction for the formation of said acid, and liberating protons and electrons with use of a catalyst optimised for this reaction, if starting from said alcohol, in an even prior preceding reaction step exposing it to a desired anodic reaction for the formation of said aldehyde, and liberating protons and electrons with use of a catalyst optimised for this reaction, and if the formed alcohol with one carbon atom less than said acid is not methanol, exposing it to the above described series of reaction steps until the formed alcohol is methanol, after which the methanol is exposed to the series of reaction steps.

Correspondingly, the object of the fuel cell unit mentioned in the introduction is achieved according to the invention by the unit being adapted to use as fuel an aliphatic, short chain, water soluble, liquid alcohol of the general formula RCH₂OH, aldehyde of the general formula RCHO, or acid of the general formula RCOOH, where R denotes H, CH₃, C₂H₅ or C₃H₇, and the unit being divided into a plurality of cells that are connected flow-wise in series for the performance of a multi-step anodic reaction, each cell having a catalyst optimised for the reaction step to be conducted in the cell.

By such a splitting of the method and of the fuel cell unit into a plurality of steps, the reactions can be refined and controlled in order to increase the yield, which results in higher power density. The flow-wise connection in series decreases the risk of different reaction products reacting with each other in an undesired manner and the risk that the reactions run in the wrong direction.

Suitably, the method is such that the alcohol is oxidised to aldehyde in the anodic reaction

RCH₂OH→RCHO+2H⁺+2e⁻ (a)

while using a catalyst optimised for this reaction (a),
that the aldehyde is oxidised to form an acid in the anodic reaction

RCHO+H₂O→RCOOH+2H⁺+2e⁻ (b)

while using a catalyst optimised for this reaction (b), and
that the acid is oxidised to form carbon dioxide and alcohol, or water, respectively, if R denotes H, in the anodic reaction

RCOOH+H₂O→CO₂+ROH+2H⁺+2e⁻ (c)

while using a catalyst optimised for this reaction (c).

It is thereby suitable to use, as a catalyst for the anodic reaction in the oxidation of alcohol to aldehyde, a catalyst containing 60-94% Ag, 5-30% Te and/or Ru, and 1-10% Pt alone or in combination with Au and/or TiO₂, preferably at the ratio of about 90:9:1, to use, as a catalyst for the anodic reaction in the oxidation of aldehyde to acid, SiO₂ and TiO₂ in combination with Ag, and to use, as a catalyst for the anodic reaction in the oxidation of acid to alcohol, or to water if R denotes H, Ag alone or in combination with TiO₂ and/or Te. In that way the desired reactions can be refined and controlled for better utilisation of the methanol and to increase power density.

Oxygen, such as oxygen in air, can be used as oxidant at the cathode, but preferably hydrogen peroxide is used, suitably together with a catalyst of carbon powder (carbon black), anthraquinone and Ag for the following cathodic reaction (d) in each step

H₂O₂+2H⁺+2e⁻→2H₂O (d).

By using hydrogen peroxide as oxidant instead of air, the advantage is attained that much lower volume flows are required. It is furthermore the case for air that E⁰=1.227 V, while for hydrogen peroxide E⁰=1.766 V. Using hydrogen peroxide as oxidant will accordingly result in higher voltage and thereby higher power.

The three reaction steps are suitably conducted in three cells that are connected flow-wise in series in a fuel cell unit and the supply of oxidant to the different steps is suitably controlled such that the reactions on the anodic and the cathodic sides are in stoichiometric balance with each other in every single step. Thereby, the reactions can be more reliably refined and controlled in order to increase yield.

The fuel cell unit is preferably such that the first cell on the anodic side has a catalyst containing 60-94% Ag, 5-30% Te and/or Ru, and 1-10% Pt alone or in combination with Au and/or TiO₂, preferably at the ratio of about 90:9:1, for conducting the following anodic reaction (a)

RCH₂OH→RCHO+2H⁺+2e⁻ (a)

the second cell has a catalyst of SiO₂ and TiO₂ in combination with Ag, for conducting the following anodic reaction (b)

RCHO+H₂O→RCOOH+2H⁺+2e⁻ (b)

and that the third cell has a catalyst of Ag alone or in combination with TiO₂ and/or Te, for conducting the following anodic reaction (c)

RCOOH+H₂O→CO₂+ROH+2H⁺+2e⁻ (c).

Suitably, all cells are designed to use a liquid oxidant and all cells on the cathodic side have a catalyst of carbon powder (carbon black), anthraquinone and Ag and phenolic resin for the use of hydrogen peroxide as liquid oxidant in the following cathodic reaction (d)

H₂O₂+2H⁺+2e⁻→2H₂O (d).

The advantages of using hydrogen peroxide as oxidant instead of air have been discussed above.

Preferably, the membrane constitutes a carrier for the catalysts on the anodic side as well as on the cathodic side. Thereby, a compact design and a high power density is achieved.

It is suitable that the anode, the cathode and the membrane are formed by thin plates of a thickness of less than 1 mm and having one planar side, attached to each other, and that the anode and the cathode, on their sides facing the membrane, are provided with a surface structure that results in optimised liquid flow over essentially the entire side of the plate.

It is also suitable that the surface structure consists of channels having a waved cross-section. Such channels are easy to achieve and will enable a desired flow pattern.

Suitably, the thin anodic and cathodic plates consist of sheet metal with a thickness in the magnitude of from 0.6 mm down to 0.1 mm, preferably 0.3 mm, and the channels have a width in the magnitude of 2 mm up to 3 mm and a depth in the magnitude of from 0.5 mm down to 0.05 mm. In that way the dimensions of the fuel cell units can be decreased and at the same time the desired reactions can be controlled for better utilisation of the methanol and to increase power density.

Preferably, the membrane consists of glass that suitably has been doped to allow for passage of protons/hydroxonium ions. In practice, a glass membrane is insoluble in the reactants in the cell and accordingly it is not affected by these. Moreover, it is not permeable to other ions.

In a first preferred embodiment the fuel cell unit is designed to be driven by methanol and it comprises three cells that are connected flow-wise in series, the first cell oxidising methanol to formaldehyde, the second cell oxidising formaldehyde to formic acid and the third cell oxidising formic acid to carbon dioxide and water.

In a second embodiment, the fuel cell unit is designed to be driven by ethanol and comprises six cells that are connected flow-wise in series. The first cell oxidises ethanol to acetaldehyde, the second acetaldehyde to acetic acid and the third acetic acid to carbon dioxide and methanol. The fourth cell oxidises methanol to formaldehyde, the fifth formaldehyde to formic acid and the sixth formic acid to carbon dioxide and water, as is described above. When using for example motor vehicles, such a fuel cell unit has the advantage that it is easy to switch between ethanol operation and methanol operation, such that is it possible to use the fuel that is available and/or most suitable at the moment.

Naturally, the system with cells in groups of three for stepwise oxidation of a first alcohol to a second alcohol with one carbon atom less, can be expanded to the use of any aliphatic, short chain, water soluble, liquid alcohol, aldehyde or acid as starting material. If desired it is for example quite possible to oxidise, in a first cell of ten, e.g. butyric acid to propyl alcohol and water, in the next cell to oxidise the propyl alcohol to propion aldehyde, in the next to oxidise the propion aldehyde to propion acid, in the next to oxidise the propion acid to carbon dioxide and ethanol, in order then to continue in the remaining six cells with the oxidation of the ethanol to carbon dioxide and water, as has been described above.

### BRIEF DESCRIPTION OF THE ENCLOSED DRAWINGS

In the following, the invention will be described in greater detail with reference to the preferred embodiments and the enclosed drawings.

FIG. 1 is a principle flowchart showing a preferred embodiment of a fuel cell unit of DMFC type, in which liquid methanol is stepwise oxidised in fuel cells to form carbon dioxide and water.

FIG. 2 is a view in cross-section over the fuel cell unit according to FIG. 1, showing a preferred arrangement of electrodes, intermediate membranes and flow channels.

FIGS. 3 and 4 are planar views over a couple of different flow patterns in which the reactants can be lead inside each unit.

### DETAILED DESCRIPTION OF PREFERRED EMBODIMENTS

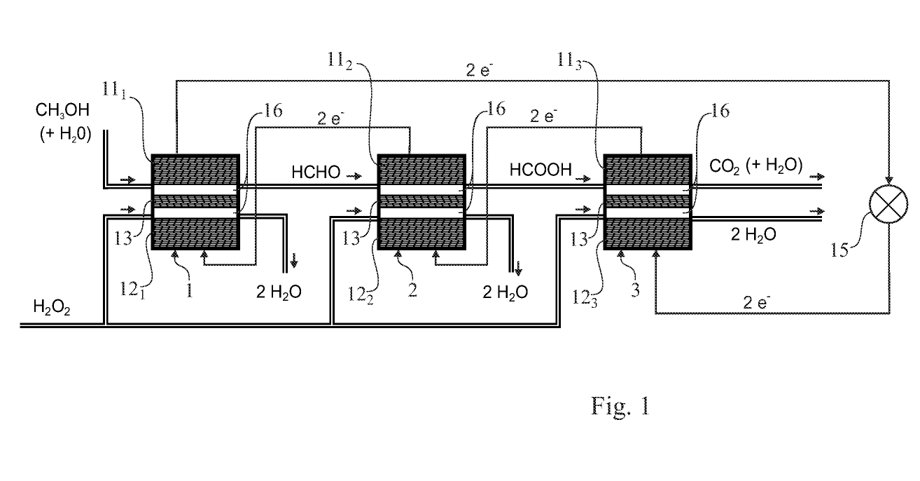

The principle flow chart in FIG. 1 shows a preferred embodiment of a fuel cell unit of DMFC type according to the invention. In the fuel cell unit an aliphatic, short chain, water soluble, liquid starting alcohol of the general formula RCH₂OH, such as methanol, is oxidised in fuel cells to form carbon dioxide and an alcohol with one carbon atom less than the starting alcohol, or water if the starting alcohol contained a single carbon atom. The shown fuel cell unit comprises three fuel cells 1, 2 and 3 that are connected flow-wise in series, for conducting the step-wise oxidation in three separate steps, where each fuel cell comprises an anode 11, a cathode 12 and a membrane 13 that separates these from each other.

In s first step in cell 1, the starting alcohol, such as methanol, is exposed to a first desired anodic reaction for oxidation of the alcohol to aldehyde and liberation of protons and electrons, while using a catalyst optimised for this first reaction; the reaction products from the first step are led to a second step in cell 2, in which a second desired anodic reaction is conducted for oxidation of the aldehyde to acid and liberation of protons and electrons, while using a catalyst optimised for this second reaction; the reaction products from the second step are lead to a third step in cell 3, in which a third desired anodic reaction is conducted for oxidation of the acid to carbon dioxide and an alcohol with one carbon atom less than the starting alcohol, or water if the starting alcohol contained a single carbon atom, and liberation of protons and electrons, while using a catalyst optimised for this third reaction.

On the anodic side, the starting alcohol RCH₂OH, where R denotes H, CH₃, C₂H₅ or C₃H₇, is oxidised to aldehyde by the reaction

RCH₂OH→RCHO+2H⁺+2e⁻ (a)

while using a catalyst optimised for this reaction (a), suitably a catalyst containing 60-94% Ag, 5-30% Te and/or Ru, and 1-10% Pt alone or in combination with Au and/or TiO₂, preferably at the ratio of about 90:9:1,
in the second step, the obtained aldehyde is oxidised to acid by the reaction

RCHO+H₂O→RCOOH+2H⁺+2e⁻ (b)

while using a catalyst optimised for this reaction (b), suitably SiO₂ and TiO₂ in combination with Ag, and
in the third step, the obtained formic acid is oxidised to carbon dioxide and an alcohol with one carbon atom less than said acid, or water if R denotes H, by the reaction

RCOOH+H₂O→CO₂+ROH+2H⁺+2e⁻ (c)

while using a catalyst optimised for this reaction (c). suitably Ag alone or in combination with TiO₂ and/or Te.

By separating the oxidation of the alcohol to carbon dioxide and water in several steps, the desired reactions can be refined and controlled with catalysts optimised for each step, such that the alcohol is better utilised and the power density is increased. In the following the case will be described in which the alcohol is methanol.

For the oxidation of methanol to acetaldehyde E⁰≈0.9 V, for the oxidation of acetaldehyde to formic acid E⁰≈0.4 V, and for the oxidation of formic acid to carbon dioxide E⁰≈0.2 V, and this together will give about 1.5-1.6 V at low load. When conversion is good, heat can be withdrawn from the middle cell 2.

In the embodiment shown in FIG. 1, freshly supplied hydrogen peroxide is reduced in each step on the cathodic side, to form water by the reaction

H₂O₂+2H⁺+2e⁻→2H₂O (d)

while using a catalyst of carbon powder (carbon black), anthraquinone and Ag and phenolic resin. The supply of oxidant to the different steps is suitably controlled such that the reactions on the anodic and the cathodic sides are in stoichiometric balance with each other in every separate step. Thereby, the reactions can be more reliably refined and can be controlled by conventional, not shown control equipment, such that the yield can be increased. It is possible, but not preferred, to use oxygen, such as oxygen in the air, as oxidant. By using hydrogen peroxide as oxidant instead of air, the advantage is attained that much lower volume flows are required. It is furthermore the case for air that E⁰=1.227 V, while for hydrogen peroxide E⁰=1.766 V. Using hydrogen peroxide as oxidant will accordingly result in higher voltage and thereby higher power. It is furthermore an advantage to have liquid phase on both sides of the membrane 13.

Anthraquinone (CAS no. 84-65-1) is a crystalline powder that has a melting point of 286° C. and that is insoluble in water and alcohol but soluble in nitrobenzene and aniline. The catalyst can be produced by mixing carbon powder (carbon black), anthraquinone and silver with e.g. phenolic resin, after which it is formed into a coating that is allowed to dry. The coating is then released from its support, is crushed and finely grinded, after which the obtained powder is slurried in a suitable solvent, is applied where desired, after which the solvent is allowed to evaporate.

The three fuel cells 1, 2 and 3 are also electrically connected in series. Two electrons are going from the anode 11₁ in step one to the cathode 12₃ in step three, via a load 15, shown in the form of a bulb; two electrons are going from the anode 11₃ in step three to the cathode 12₂ in step two; and two electrons are going from the anode 11₂ in step two to the cathode 12₁ in step one. In all three cells 1, 2 and 3, formed protons/hydroxonium ions are going from the anode 11, through the membrane 13, to the cathode 12.

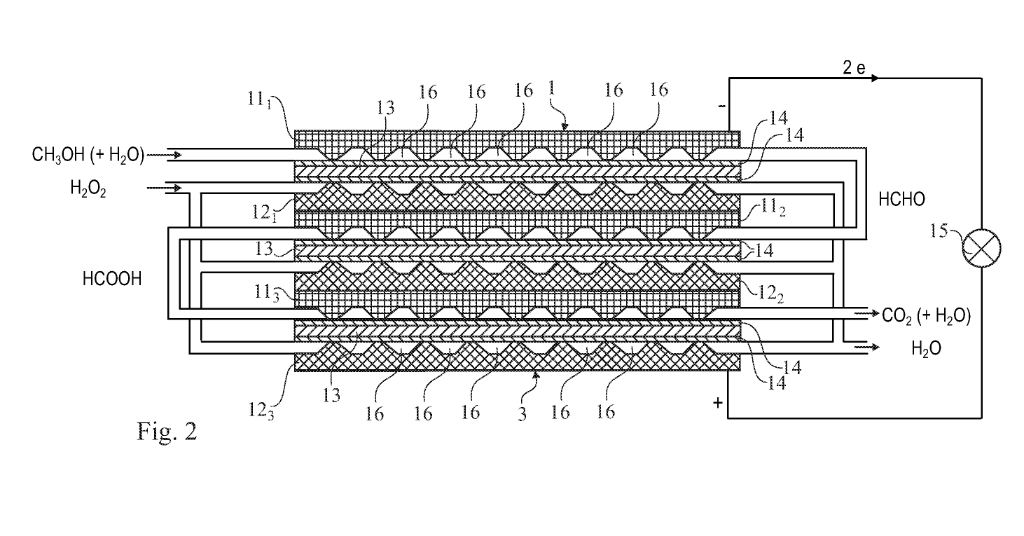

FIG. 2 is a view in cross-section over the fuel cell unit according to FIG. 1, showing a preferred arrangement of electrodes 11, 12, intermediate membranes 13 and flow channels. The anodes 11, the cathodes 12 and the membranes 13 are formed by thin plates or sheets that are attached to each other in order to form a package or a pile. The joining can be mechanical, e.g. by not shown connecting rods, but preferably not shown joints of a suitable glue, e.g. of silicone type, are used in order to hold the plates/sheets together. Between the membrane 13 and the anode 11 and between the membrane 13 and the cathode 12, a surface structure 16 is arranged that will give an optimised liquid flow over essentially the entire side of the plates. It is furthermore clear from FIG. 2 that the electrical connection in series is performed such that the plate that constitutes cathode 12, in step one is in electrically conducting surface contact with the plate that is anode 11₂ in step two, and that the plate that constitutes cathode 12₂ in step two is in electrically conducting surface contact with the plate that is anode 11₃ in step three. The flow lines shown in FIG. 1, between the separate fuel cells 1, 2 and 3, are constituted by flow connections that are formed in the plate package/pile but also by externally positioned flow connections shown in FIG. 2.

The membrane 13 can be constituted by a conventional PEM membrane of Nafion™, but in a preferred embodiment the membrane consists of a thin glass plate that is preferably doped to allow for migration of protons/hydroxonium ions from one membrane side to the other. The glass may advantageously be constituted by cheap glass grades, such as soda lime glass and green glass. When such glass is made thin its resilience and its specific durability against mechanical load will increase. Several different metals are conceivable as doping agents in the glass, but preferably silver in the form of silver chloride is used, which is reasonably cheap. The doping agent as well as the small thickness of the glass facilitates the migration of protons/hydroxonium ions through the membrane. Moreover, the glass stops the passage of other ions and molecules, such as methanol, and it is not electrically conducting, which means that electrons from the cathode cannot pass through the membrane to the anode. Accordingly, no migration of methanol can take place from the anode 11 to the cathode 12, which means that there is no fuel loss due to migration of methanol and no formation of carbon monoxide at the cathode 12, which could otherwise decrease the efficiency of a platinum catalyst that is optionally used there.

In the preferred embodiment shown in FIG. 2, the anode 11, the cathode 12 and the membrane 13 have thicknesses of less than 1 mm. The anode 11 as well as the cathode 12 have one planar side and said surface structure 16, that gives an optimised liquid flow over essentially the entire side of the plate, is arranged on the anode 11 as well as on the cathode 12, while both sides of the intermediate membrane 13 are planar. The planar side of the cathode 12, in cell 1 in the fuel cell unit shown in FIG. 1 is then in abutting contact with the planar side of the anode 11₂ in cell 2, and so on. It is easily realised that a fuel cell 1, 2, 3 may have an anode 11, a membrane 13 as well as a cathode 12 that all have a planar side facing a side with surface structure 16 on an adjoining plate and vice versa, or an anode 11 and a cathode 12 with planar sides facing the membrane 13 whose both sides are provided with surface structure 16.

Suitably, the anode 11 as well as the cathode 12 are constituted of thin metal sheets of a material that is electrically conducting and resistant to the reactants, such as stainless steel, with a thickness in the magnitude of from 0.6 mm down to 0.1 mm, preferably 0.3 mm. Any surface structure 16 in the membrane 13 as well as the surface structure in the anode 11 and the cathode 12 can be formed by channels of waved cross-section. Suitably, the channels 16 have a width in the magnitude of 2 mm up to 3 mm and a depth in the magnitude of from 0.5 mm down to 0.05 mm. Any surface structure 16 in the glass membrane 13 is produced for example by etching and in the anode and the cathode plates 11, 12 it is produced by adiabatic forming, also called High Impact Forming. One example of such forming is disclosed in U.S. Pat. No. 6,821,471. Plates of the desired surface structure or flow pattern manufactured by adiabatic forming have a cost of only about a tenth of the cost of plates on which the flow pattern have been achieved by chip cutting removal.

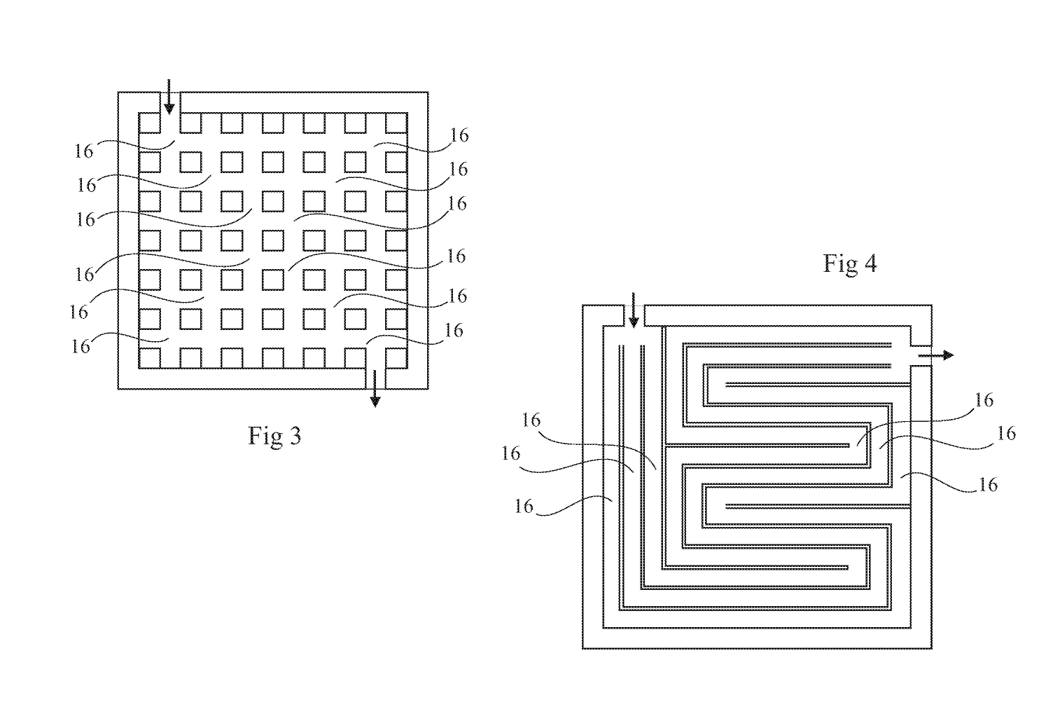

FIGS. 3 and 4 show a couple of different surface structures or flow patterns 16 that will give an optimised liquid flow over essentially the entire side of the plate. In FIG. 3, parallel channels have been repeatedly perforated laterally, such that the entire surface structure consists of shoulders arranged in a checked pattern and the channels 16 are arranged in a pattern similar to a grating. Finally, FIG. 4 shows that meander shaped channels 16 that run in parallel also can be used. In all cases including different possible flow paths one should strive to make them equally long from inlet to outlet.

Preferably, the glass plate 13 has one planar side and the planar side is suitably provided with a catalyst that is essential for the conducting of an anodic reaction or a cathodic reaction in the fuel cell or the reactor, and preferably the catalyst is fused to the glass surface on one side of the membrane. It is thereby also suitable that the other side of the glass plate 13 is planar and that a catalyst, that is essential for the conducting of the cathodic reaction, is fused to the glass surface on the other side of the membrane. As is clear from FIG. 2, in which the two membranes 13 are moreover shown to be provided with a layer 14 of catalyst on both sides, the constructing of a compact pile of fuel cells 1, 2, 3 with electrodes 11, 12 of the same thin plate shape having one planar side and one side with surface structure is facilitated, whereby a high power density can be achieved.

As is mentioned above, the optimised catalyst for the second step is suitably constituted by SiO₂, TiO₂ and Ag. In case the membrane 13 consists of glass, SiO₂ is already comprised in the glass, which means that only TiO₂ and Ag need to be applied separately.

By the catalyst suitably being fused to the surface of the glass, it is protected against mechanical damage at the same time as the compact construction that gives a high power density is maintained. The fusing is performed e.g. by laser, suitably in an inert atmosphere, and before the fusing the catalyst particles should naturally have been made really small, such by grinding in a ball mill, in order to increase the catalyst area.

Naturally, catalysts can also be carried by one or both electrodes 11, 12. Alternatively, at least one of the catalysts, such as the one containing anthraquinone and silver, could be arranged in a not shown intermediate, separate carrier of e.g. carbon fibre felt. Such an arrangement will however mean that the diffusion will be slowed down, which means that this variant is less preferable although conceivable.

The above mentioned catalysts are not specific only to the case that R denotes H but can be used to catalyse the corresponding reactions also when R denotes CH₃, C₂H₅ or C₃H₇.

As is clear from the description above, with reference to the enclosed drawings, the fuel cell unit is, in a first preferred embodiment, designed to be driven by methanol and it comprises three cells that are connected flow-wise in series, the first cell oxidising methanol to formaldehyde, the second cell oxidising formaldehyde to formic acid and the third cell oxidising formic acid to carbon dioxide and water.

In a second, but not shown embodiment, the fuel cell unit is designed to be driven by ethanol and comprises six cells that are connected flow-wise in series, where the first cell oxidises ethanol to acetaldehyde, the second cell oxidises acetaldehyde to acetic acid, the third cell oxidises acetic acid to carbon dioxide and methanol, the fourth cell oxidises methanol to formaldehyde, the fifth cell oxidises formaldehyde to formic acid and the sixth cell oxidises formic acid to carbon dioxide and water. When using for example motor vehicles, such a fuel cell unit has the advantage that it is easy to switch between ethanol operation and methanol operation, such that is it possible to use the fuel that is available and/or most suitable at the moment.

Naturally, the system with cells in groups of three for stepwise oxidation of a first alcohol to a second alcohol with one carbon atom less, can be expanded to the use of any aliphatic, short chain, water soluble, liquid alcohol, aldehyde or acid as starting material. If desired it is for example quite possible to oxidise, in a first cell of ten, e.g. butyric acid to propyl alcohol and water, in the next cell to oxidise the propyl alcohol to propion aldehyde, in the next to oxidise the propion aldehyde to propion acid, in the next to oxidise the propion acid to carbon dioxide and ethanol, in order then to continue in the remaining six cells with the oxidation of the ethanol to carbon dioxide and water, as has been described above. In this manner, it is possible to use, as fuel in the fuel cell unit, compounds that have not previously been considered in this context. Probably, it is also possible to choose as a starting product a compound that falls outside the above mentioned group of alcohols, aldehydes and acids, but that by a suitable anodic reaction can be oxidised by aid of a catalyst in order to end up in the group.

1. A method of operation of a fuel cell unit of DMFC type, in which an aliphatic, short chain, water soluble, liquid alcohol of the general formula RCH₂OH, aldehyde of the general formula RCHO or acid of the general formula RCOOH, where R denotes H, CH₃, C₂H₅ or C₃H₇, is oxidized to carbon dioxide and water, wherein,
if starting from said acid, exposing it to a reaction step of a desired anodic reaction for the forming of carbon dioxide, an alcohol with one carbon atom less than said acid, or, if R denotes H, water, and liberating protons and electrons with use of a catalyst optimised for this reaction,
if starting from said aldehyde, in a preceding reaction step exposing it to a desired anodic reaction for the formation of said acid, and liberating protons and electrons with use of a catalyst optimised for this reaction,
if starting from said alcohol, in an even prior preceding reaction step exposing it to a desired anodic reaction for the formation of said aldehyde, and liberating protons and electrons with use of a catalyst optimised for this reaction, and
if the formed alcohol with one carbon atom less than said acid is not methanol, exposing it to the above described series of reaction steps until the formed alcohol is methanol, after which the methanol is exposed to the series of reaction steps.

2. A method according to claim 1, wherein the alcohol is oxidised to form aldehyde in the anodic reaction
RCH₂OH→RCHO+2H⁺+2e⁻ (a)
while using a catalyst optimised for this reaction (a),
that the aldehyde is oxidised to form an acid in the anodic reaction
RCHO+H₂O→RCOOH+2H⁺+2e⁻ (b)
while using a catalyst optimised for this reaction (b), and that the acid is oxidised to form carbon dioxide and alcohol, or water, respectively, if R denotes H, in the anodic reaction
RCOOH+H₂O→CO₂+ROH+2H⁺+2e⁻ (c)
while using a catalyst optimised for this reaction (c).

3. A method according to claim 2, wherein as catalyst for the anodic reaction in the oxidation of alcohol to aldehyde is used a catalyst containing 60-94% Ag, 5-30% Te and/or Ru, and 1-10% Pt alone or in combination with Au and/or TiO₂, preferably at the ratio of about 90:9:1.

4. A method according to claim 2 wherein as catalyst for the anodic reaction in the oxidation of aldehyde to acid is used SiO₂ and TiO₂ in combination with Ag.

5. A method according to claim 2, wherein as catalyst for the anodic reaction in the oxidation of acid to carbon dioxide and alcohol or water, respectively, is used Ag alone or in combination with TiO₂ and/or Te.

6. A method according to claim 2, wherein the oxidant used at the cathode is oxygen, such as oxygen in air.

7. A method according to claim 2, wherein the oxidant used at the cathode is hydrogen peroxide.

8. A method according to claim 7, wherein the hydrogen peroxide is used in combination with a catalyst of carbon powder, Anthraquinone and Ag for the following cathodic reaction in each step
H₂O₂+2H⁺+2e⁻→2H₂O (d).

9. A method according to claim 2, wherein the reaction steps are conducted in cells that are connected flow-wise in series in a fuel cell unit.

10. A method according to claim 2, wherein the supply of oxidant to the different steps is controlled such that the reactions on the anodic and the cathodic sides are in stoichiometric balance with each other in every separate step.

11. A fuel cell unit of DMFC type, which unit comprises an anodic side having an anode and a catalyst for the anodic reaction, a cathodic side having a cathode and a catalyst for the cathodic reaction, as well as an intermediate membrane that separates the anodic and cathodic sides from each other, wherein the unit is adapted to use as fuel an aliphatic, short chain, water soluble, liquid alcohol of the general formula RCH₂OH, aldehyde of the general formula RCHO, or acid of the general formula RCOOH, where R denotes H, CH₃, C₂H₅ and C₃H₇, and in that the unit is divided into a plurality of cells that are connected flow-wise in series for the performance of a multi-step anodic reaction, the anodic side and the cathodic side in each cell having a catalyst optimised for the reaction step to be conducted in the cell.

12. A fuel cell unit according to claim 11, wherein a first cell on the anodic side has a catalyst containing 60-94% Ag, 5-30% Te and/or Ru, and 1-10% Pt alone or in combination with Au and/or TiO₂, preferably at the ratio of about 90:9:1, for conducting the following anodic reaction (a)
RCH₂OH→RCHO+2H⁺+2e⁻ (a)
a second, flow-wise following, cell has a catalyst of SiO₂ and TiO₂ in combination with Ag, for conducting the following anodic reaction (b)
RCHO+H₂O→RCOOH+2H⁺+2e⁻ (b)
and that a third cell (3), flow-wise following after the second cell, has a catalyst of Ag alone or in combination with TiO₂ and/or Te, for conducting the following anodic reaction (c)
RCOOH+H₂O CO₂+ROH+2H⁺+2e⁻ (c).

13. A fuel cell unit according to claim 12, wherein all cells are designed to use a liquid oxidant.

14. fuel cell unit according to claim 13, wherein all cells on the cathodic side has a catalyst of carbon powder, anthraquinone and Ag for using hydrogen peroxide as liquid oxidant in the following cathodic reaction (d)
H₂O₂+2 H⁺+2e⁻→2H₂O (d).

15. A fuel cell unit according to claim 11, wherein the membrane constitutes a carrier for the catalysts on the anodic side and/or the cathodic side.

16. A fuel cell unit according to claim 11, wherein the anode, the cathode and the membrane are constituted by thin plates with a thickness of less than 1 mm and a planar side, attached to each other, that both sides of the membrane are planar, and that the anode and the cathode each have one planar side and on its respective opposite side facing the membrane is provided with a surface structure that will give an optimised liquid flow over essentially the entire side of the plate.

17. A fuel cell unit according to claim 16, wherein the surface structure is constituted by channels having a waved cross-section.

18. A fuel cell unit according to claim 17, wherein the thin anodic and cathodic plates consist of sheet metal with a thickness in the magnitude of from 0.6 mm down to 0.1 mm, preferably 0.3 mm, and the channels have a width in the magnitude of 2 mm up to 3 mm and a depth in the magnitude of from 0.5 mm down to 0.05 mm.

19. A fuel cell unit according to claim 11, wherein the membrane consists of glass.

20. A fuel cell unit according to claim 19, wherein the glass is doped to allow for passage of protons/hydroxonium ions.

21. A fuel cell unit according to claim 11, for the use of liquid methanol as fuel, wherein the unit comprises three cells that are connected flow-wise in series, of which a first cell has a catalyst that is optimised to conduct the following anodic reaction (a)
CH₃OH→HCHO+2H⁺+2e⁻ (a)
a second, flow-wise following, cell has a catalyst that is optimised to conduct the following anodic reaction (b)
HCHO+H₂O→HCOOH+2H⁺+2e⁻ (b)
and in that a third cell, flow-wise following after the second cell, has a catalyst that is optimised to conduct the following anodic reaction (c)
HCOOH+H₂O→CO₂+H₂O+2H⁺+2e⁻ (c).

22. A fuel cell unit according to claim 11 for the use of liquid ethanol as fuel, wherein the unit comprises six cells that are connected flow-wise in series, of which a first cell has a catalyst that is optimised to conduct the following anodic reaction (a)
C₂H₅OH→CH₃CHO+2H⁺+2e⁻ (a)
a second, flow-wise following, cell has a catalyst that is optimised to conduct the following anodic reaction (b)
CH₃CHO+H₂O→CH₃COOH+2H⁺+2e⁻ (b)
a third cell, flow-wise following after the second cell, has a catalyst that is optimised to conduct the following anodic reaction (c)
CH₃COOH+H₂O CO₂+CH₃OH+2H⁺+2e⁻ (c)
a fourth cell, flow-wise following after the third cell, has a catalyst that is optimised to conduct the following anodic reaction (d)
CH₃OH→HCHO+2H⁺+2e⁻ (d)
a fifth cell, flow-wise following after the fourth cell, has a catalyst that is optimised to conduct the following anodic reaction (e)
HCHO+H₂O→HCOOH+2 H⁺+2e⁻ (e)
and in that a sixth cell, flow-wise following after the fifth cell, has a catalyst that is optimised to conduct the following anodic reaction (f)
HCOOH+H₂O→CO₂+H₂O+2H⁺+2e⁻ (f).
